(19) United States
(12) Patent Application Publication
(10) Pub. No.: US 2011/0114351 A1
(43) Pub. Date: May 19, 2011

(54) TUBULAR CONDUCTOR ARRANGEMENT COMPRISING A FLUID-TIGHT ENCLOSURE TUBE

(75) Inventor: Hermann Koch, Gerhardshofen (DE)

(73) Assignee: SIEMENS AKTIENGESELLSCHAFT, MÜNCHEN (DE)

(21) Appl. No.: 13/002,069

(22) PCT Filed: Jun. 24, 2009
(86) PCT No.: PCT/EP2009/057884

§ 371 Date: Dec. 30, 2010

(30) Foreign Application Priority Data
Jun. 30, 2008 (DE) 10 2008 030 997.4

(51) Int. Cl. H01B 9/00

(52) U.S. Cl. 174/24

(57) ABSTRACT

A tubular conductor assembly includes a fluid-tight enclosure tube which is part of an enclosure section for a fluid. An electric phase conductor is arranged in such a way as to be insulated relative to the fluid-tight enclosure tube. The tubular conductor assembly further includes a protective tube which can be moved along a tube axis relative to the enclosure tube. An anchor point is formed between the protective tube and the enclosure tube.

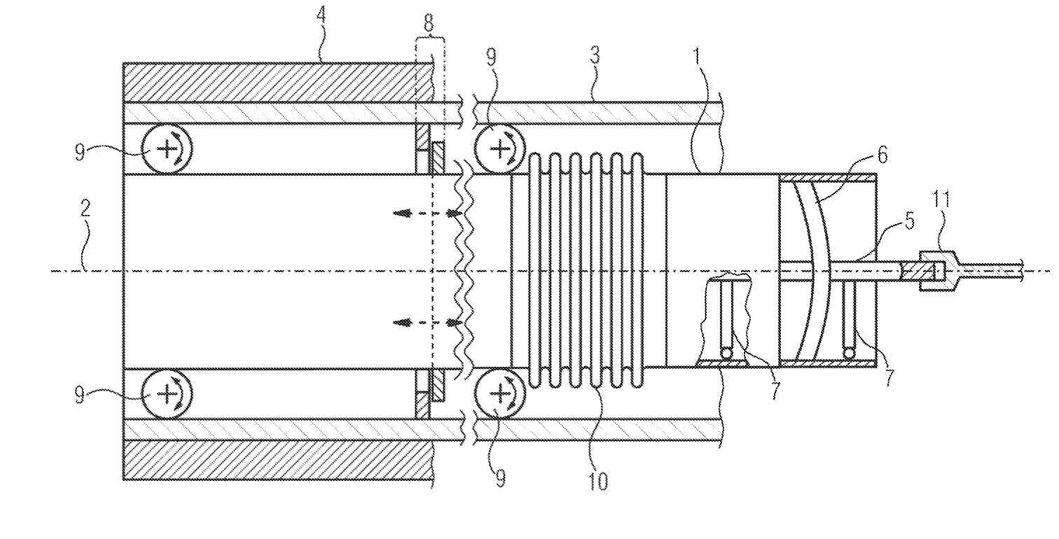

The invention relates to a tubular conductor arrangement comprising a fluid-tight enclosure tube which is part of an enclosure portion for a fluid and has a tube axis, and comprising at least one electrical phase conductor surrounded by the fluid-tight enclosure tube and arranged so as to be electrically insulated with respect to the latter, and also a protective tube movable along the tube axis in relation to the enclosure tube.

A tubular conductor arrangement of this type is known, for example, from U.S. Pat. No. 5,496,965. A fluid-tight enclosure tube is used there which receives a fluid inside it. Furthermore, a plurality of phase conductors are arranged within the fluid so as to be insulated electrically and surrounded by the enclosure tube. The phase conductors are surrounded by a protective tube which is likewise arranged within the fluid. The protective tube, together with the phase conductors, is movable in relation to the enclosure tube. For this purpose, a plurality of roller bearings are arranged on the circumference of the protective tube.

When the known tubular conductor arrangement is being installed, first the fluid-tight enclosure tube is driven forward and then the protective tube, together with the phase conductors located in it, is pushed into the enclosure tube. During the mounting operation, the protective tube affords mechanical protection especially when the phase conductors are being introduced or pushed forward outside the enclosure tube.

On account of the roller bearings which remain within the fluid, arbitrary relative movements between the enclosure tube and protective tube occur in the event of temperature changes. The object of the invention is to specify an arrangement in which relative movement between the enclosure tube and the protective tube can be influenced.

In a tubular conductor arrangement of the type initially mentioned, the object is achieved in that an anchor point is formed between the protective tube and the enclosure tube.

In the known arrangement, different length changes of the enclosure tube and protective tube occur, depending on the temperature fluctuation. This results in a random setting of the positions of the protective tube and enclosure tube in relation to one another.

Providing an anchor point between the protective tube and enclosure tube restricts the relative movability of the protective tube and enclosure tube. By an anchor point being provided, a fixed point is formed between the two tubes and defines a location from which thermal expansions can extend. The anchor point used may be, for example, stops between the protective tube and enclosure tube. In this case, there may be provision for the fixed point to be designed as a rigid connection. The anchor point forms an angularly rigid connection between the protective tube and enclosure tube. There may also be provision, however, for the stop to limit movability between the enclosure tube and protective tube solely in a specific direction having a specific sense of direction. In this case, the anchor point can be reversibly cancelled and restored. The anchor point should in this case be selected in such a way that it preferably provides a connection between surface areas of the protective tube and enclosure tube. Thus, for example, it is possible, if the protective tube is arranged outside the fluid, that is to say the enclosure tube extends through the protective tube, to form an anchor point between the outer surface area of the enclosure tube and the inner surface area of the protective tube. The anchor point may in this case be configured in such a way that the protective tube and enclosure tube are directly connected to one another. There may also be provision, however, for suitable subassemblies to cause the enclosure tube and protective tube to be fixed indirectly with respect to one another. For example, existing fixed bearings or the like may thus be used for forming an anchor point.

The enclosure tube extends along the tube axis. The enclosure tube itself may in this case delimit an enclosure portion at least in the radial direction with respect to the tube axis. An enclosure portion delimits volume which closes off a fluid hermetically. Thus, for example, it is possible to insert into the course of the enclosure tube gas-tight barriers which subdivide the enclosure tube into different enclosure portions. The barriers then in each case delimit an enclosure portion of the end faces. The barriers may in this case be designed in such a way that a barrier in each case separates mutually adjacent enclosure portions from one another.

There may in this case be provision, in an advantageous refinement, for the anchor point between the protective tube and enclosure tube to be arranged so as to be spaced apart markedly from the end faces of the enclosure portion, in particular approximately centrally between these.

Tubular conductor arrangements according to the invention are used in order to transmit high electrical energy powers over lengthier distances. Typically, a tubular conductor arrangement of this type is subdivided into individual portions which attain lengths of up to a few kilometers. Typically, the enclosure tube is subdivided into a plurality of enclosure portions which in each case receive a closed-off fluid quantity. Suitable fluids are, for example, insulating oils, insulating gases, such as sulfur hexafluoride, nitrogen, gas mixtures and further suitable gases or mixtures. The protective tube may, for example, have a multi-shell structure, that is to say the protective tube may have a metallic layer which is provided with appropriate anticorrosion coatings and may additionally have a concrete jacket, for example, for the purpose of stabilizing the protective tube. A protective tube of such massive build has a corresponding coefficient of thermal expansion. Typically, enclosure tubes have a single-layer structure, for example aluminum or aluminum alloys are used for forming the enclosure housings. Thus, for example, there may be provision for a continuous protective tube to receive inside it an enclosure tube which is subdivided into a plurality of portions, that is to say into a plurality of enclosure portions. For example, such an enclosure portion may be closed off by means of a barrier located inside the enclosure tube. Such a barrier may be formed, for example, by a disk insulator which may likewise be employed for holding the phase conductor in the enclosure tube in an electrically insulated manner. In this case, it is advantageous if an anchor point is arranged so as to be spaced apart from the respective end faces of the enclosure portions. Advantageously, the anchor point is to be provided as centrally as possible. It is consequently possible to allow defined linear expansion with respect to the tube axis on both sides of the anchor point.

In a further advantageous refinement, there may be provision for the enclosure tube to be mounted, spaced apart from the anchor point, on at least one loose bearing on the protective tube.

The use of loose bearings makes it possible to maintain a predetermined spacing between the enclosure tube and protective tube and, in addition, to allow the two tubes to be guided.

Suitable loose bearings are, for example, roller bearings or plain bearings. In this case, for example, there may be provision whereby, if the protective tube and enclosure tube are arranged coaxially with respect to one another, correspondingly dimensioned rollers are provided on loose bearings and roll, on the one hand, on an inner surface area and, on the other hand, on an outer surface area of the enclosure tube and of the protective tube respectively. The tubes can thereby be spaced apart and centered with respect to one another.

Furthermore, there may advantageously be provision for the phase conductor to be supported via a holding insulator fixed in relation to the enclosure tube, the holding insulator being arranged so as to be offset to the anchor point with respect to the tube axis.

A holding insulator fixed in relation to the enclosure tube allows the phase conductor to be fixed in position. The holding insulator may be configured, for example, as a fluid-tight disk insulator. In this case, the holding insulator may deviate from an ideal disk form and, for example, have conical forms or rib structures on one surface. A holding insulator of this type may serve for forming a bulkhead, with the result that an enclosure portion is delimited in the axial direction. A corresponding holding insulator is then arranged on an enclosure portion on each of the end faces. The fixed holding insulators are located on the respective enclosure portion on the end faces with respective to the tube axis. It is advantageous if exactly one anchor point is provided in the region of an enclosure portion, in which case this anchor point should be positioned so as to be spaced markedly apart from the end faces of the enclosure portion. A central arrangement with respect to the end faces of an enclosure portion allows the enclosure portion to expand as uniformly as possible on both sides of the anchor point.

Advantageously, there may be further provision for a holding insulator movable in relation to the enclosure tube to be arranged, adjacently to the fixed holding insulator, on the phase conductor.

Furthermore, a holding insulator movable in relation to the enclosure tube also allows relative movements of the phase conductor with respect to the enclosure tube and, because of the movability of the enclosure tube in relation to the protective tube, also movability of the phase conductor in relation to the protective tube. For this purpose, for example, there may be provision for the movable holding insulator to be connected to the phase conductor in an angularly rigid manner, so that movements of the phase conductor are transmitted to the movable holding insulator and, for example, the movable holding insulator can slide on an inner surface area of the enclosure tube. For the compensation of length changes, there may be provision for the phase conductor to have in portions plug connections which, for example, cause a bolt-shaped portion of the phase conductor to project into a tulip-shaped portion of the phase conductor, so that length changes can be compensated, free of mechanical stresses, in these plug connections.

Furthermore, there may advantageously be provision for the enclosure tube to have a length compensator.

The use of a length compensator may be provided, for example, when a multiplicity of enclosure portions of an enclosure tube are arranged so as to lie one behind the other in the direction of the tube axis. In this case, portions of variable length may be inserted into the enclosure tube along the course of at least one enclosure portion. A portion of variable length may be implemented, for example, by telescopic portions or by what is known as a concertina, in which case, with regard to the telescopic portions, two tubular pieces coordinated with one another in diameter and sealed off so as to be fluid-tight engage one in the other and are movable in relation to one another. With regard to a concertina, one portion of the enclosure tube is designed to be reversibly deformable. This portion is deformed to a greater or lesser extent as a function of the linear expansion of the enclosure tube.

It is thus possible to arrange a multiplicity of enclosures inside an elongate tube and to compensate thermal expansions which occur. In this case, it is possible to dispense with such compensating arrangements on the protective tube and to prolong the latter completely continuously over enclosure portions butting one against the other.

Furthermore, there may advantageously be provision for the enclosure tube and the protective tube to have circular cross sections, the diameter ratio of protective tube to enclosure tube lying between √3 (a p̅p̅roximately 1.73) and e (approximately 2.73).

Tubes having essentially circular cross sections can be positioned in a mechanically stable manner and advantageously coaxially with respect to one another. Between the enclosure tube and protective tube, therefore, a hollow-cylindrical space is obtained in which, for example, the anchor points and loose bearings may be arranged. Furthermore, in an appropriately fluid-tight configuration of the protective tube, it is possible to fill this space, for example, with a special medium. Here, for example, there may be provision for using appropriately dried and purified air (nitrogen), so that the enclosure tube is located within a defined atmosphere. The occurrence of oxidation phenomena is thus restricted or there is no need for additional protection of the enclosure tube against oxidations. Furthermore, the space surrounding the enclosure tube may be utilized, for example, in order to carry heat within the tubular conductor arrangement by means of convection. Particularly when high energy densities are transmitted, that is to say when the phase conductor or phase conductors is or are subjected to high currents, corresponding joule heat effects occur which may exert an adverse influence. The space located between the enclosure housing and protective tube may be utilized in order to achieve appropriate cooling.

The invention is shown diagrammatically below by means of a drawing and is described in more detail hereafter.

In the drawing:

the FIGURE shows a section through a tubular conductor arrangement.

A portion of a tubular conductor arrangement is illustrated in the FIGURE. A tubular conductor arrangement of this type may have lengths of several kilometers. In order to make a complete connection between two points several kilometers away from one another, a plurality of portions shown in the FIGURE are arranged so as to lie axially one behind the other.

The tubular conductor arrangement has a fluid-tight enclosure tube 1. The fluid-tight enclosure tube 1 has an essentially circular cross section and is oriented coaxially to a tube axis 2. The tube axis 2 appears as a straight line because of the illustration in sections in the FIGURE. However, there may also be provision for installation around bends, utilizing the elasticity of the fluid-tight enclosure tube, so that a bent tube axis 2 is formed. Furthermore, the tubular conductor arrangement has a protective tube 3 which surrounds the fluid-tight enclosure tube 1. The protective tube 3 likewise has an essentially circular cross section and is arranged coaxially to the tube axis 2 and therefore also to the fluid-tight enclosure tube 1. The fluid-tight enclosure tube 1 is formed, for example, from an aluminum alloy. The protective tube 3 may, for example, have as its core a steel tube which is provided on its surfaces with corresponding anticorrosion coatings. In the present example a concrete jacket 4 is additionally arranged around the protective tube 3. The concrete jacket 4, on the one hand, serves as a surface coating of the protective tube 3 and, on the other hand, increases the mass of the tubular conductor arrangement. This ensures, in the case of installation in bodies of water, that the buoyancy of the overall regiment is reduced and mechanical protection is additionally ensured. A phase conductor 5 is arranged inside the fluid-tight enclosure tube and is washed around by an electrically insulating fluid, for example a gas or liquid, preferably sulfur hexafluoride, nitrogen or mixtures thereof. The phase conductor 5 is likewise oriented coaxially to the tube axis 2. In the present example, positioning of an individual phase conductor 5 is provided, as shown diagrammatically. There may, however, also be provision for a plurality of phase conductors 5 to be guided jointly inside the fluid-tight enclosure tube 1. The phase conductor 5 is held, spaced apart from the fluid-tight enclosure tube 1, in an electrically insulated manner by holding insulators. In this case, there is provision for a holding insulator 6 fixed in relation to the enclosure tube 1 to be configured in the form of a disk insulator which is inserted, gas-tight, into the fluid-tight enclosure tube 1. For this purpose, there may be provision for corresponding flanges to be arranged along the course of the fluid-tight enclosure tube 1, so that the fixed holding insulator 6 can be inserted gas-tight into the course of the enclosure tube 1 at a flange connection.

Preferably, the fixed holding insulator 6 forms a boundary of an enclosure portion which closes off the fluid inside it. A plurality of enclosure portions lying axially one behind the other are arranged along the course of the enclosure tube 1. Insofar as there is provision for utilizing flanges in order to introduce fixed holding insulators 6 acting as fluid-tight barriers, a boundary of an enclosure portion can also easily be recognized on the outer circumference of the enclosure tube 1.

For additionally supporting the phase conductor 5 inside an enclosure portion, a plurality of holding insulators 7 movable in relation to the enclosure tube 1 may be provided. These movable holding insulators 7 have, for example, a column-shaped configuration and, offset radially so as to run around the tube axis 2, are connected to the phase conductor 5, so that trestle-like mounting and centered guidance of the phase conductor 5 take place inside the fluid-tight enclosure tube 1. A multiplicity of movable holding insulators 7 may be arranged inside an enclosure portion which is delimited in each case on the end faces by fluid-tight holding insulators 6.

There is provision on an enclosure portion for positioning an anchor point 8. In the present exemplary embodiment, the anchor point is formed by rings running coaxially around the tube axis 2, one of the rings being connected rigidly to the inner surface area of the protective tube 3, and a ring of smaller diameter being connected rigidly to the outer surface area of the fluid-tight enclosure tube 1. There may be provision, if required, for the two rings to be additionally coupled rigidly to one another, or for only one stop to be formed which makes it possible, as required, for the two rings of the anchor point 8 to touch one another and to be lifted off.

Proceeding from the anchor point 8, which should be arranged as far as possible centrally between end face limits of an enclosure portion, thermal expansion of the enclosure tube 1 can take place in the direction of the tube axis 2 on both sides of the anchor point 8. The anchor point 8 affords a fixed point which allows a defined movement of the fluid-tight enclosure tube 1 inside the protective tube 3. An overall movement is thus distributed over the overall length of the tubular conductor arrangement. Punctiform expansion or contraction of the fluid-tight enclosure tube inside the tubular conductor arrangement is thus avoided. Separate expansion is possible for each enclosure portion. Loose bearings in the form of rollers 9 are provided on the protective tube 3 for guiding and steering the fluid-tight enclosure tube 1. The rollers 9 are dimensioned in such a way that they roll both on the inner surface area of the protective tube 3 and on the outer surface area of the fluid-tight enclosure tube 1 and thus cause the fluid-tight enclosure tube 1 and protective tube 3 to be centered and positioned.

So that the length changes, which in each case proceed from the anchor point 8, can be implemented, as free of mechanical stresses as possible, even when a multiplicity of enclosure portions are lined up with one another, a length compensator 10 is inserted into the fluid-tight enclosure tube 1. In the present exemplary embodiment, the length compensator 10 is implemented by a concertina which has increased elasticity. Depending on the thermal load upon the tubular conductor arrangement, greater or lesser compression of the length compensator 10 takes place. Alternatively, there could also be provision there for a telescopic arrangement of tubular portions which project one into the other and are correspondingly sealed off fluid-tight, on their surface areas touching one another. The length compensator 10 may be inserted into the fluid-tight enclosure tube 1, for example, by means of welded joints. Alternatively, there may also be provision for providing corresponding flanges having screw connections. So that a length change can be compensated even in the region of the phase conductor 5, there is provision for the phase conductor 5 to have portions connected to one another, the individual portions being contacted with one another via plug contacts 11. There, for example, a bolt-shaped portion of the phase conductor is surrounded by a socket-shaped portion of the phase conductor and is contacted electrically, contacting being implemented via sliding contacts. If the depth of the socket is dimensioned appropriately, sufficient space remains so that thermal expansions in the region of the plug contact can be compensated.

Relative movements in the direction of the tube axis 2 between the fluid-tight enclosure tube 1 and the protective tube 3 can be guided via the loose bearings designed in the form of rollers 9 or skids. It is advantageous if each enclosure portion is assigned exactly one anchor point approximately centrally. The anchor points may be designed as fixed bearings, so that length changes can occur on both sides of the anchor point with respect to the enclosure portion or to the end faces of the enclosure portion. The length changes take place from the anchor point 8 in each case with an opposite sense of direction (see the dotted arrows in the FIGURE). Since a multiplicity of portions shown in the FIGURE are lined up with one another, it is sufficient if a length compensator 10 is provided in the fluid-tight enclosure tube 1 and a plug contact 11 in the phase conductor 5 in each case along the one side, proceeding from the anchor point 8, since said length compensator and said plug contact can in each case implement the length compensations on an adjacent enclosure portion.

There may advantageously be provision for the protective tube 3 to be likewise of fluid-tight design, so that a defined medium can be introduced in the space formed between the enclosure tube 1 and protective tube 3 and heat can be propagated in the tubular conductor arrangement via this medium. In this case, the medium can flow within the tubular conductor arrangement, for example, by natural convection and thermal phenomena caused, for example, by joule heat effects are transported out of the inside of the tubular conductor arrangement as quickly as possible into external regions.

1-7. (canceled)

8. A tubular conductor assembly, comprising:
a fluid-tight enclosure tube being a part of an enclosure portion for a fluid, said enclosure tube having a tube axis;
at least one electrical phase conductor surrounded by said enclosure tube and electrically insulated with respect to said enclosure tube;
a protective tube movable along said tube axis relative to said enclosure tube; and
an anchor point formed between said protective tube and said enclosure tube.

9. The tubular conductor assembly according to claim 8, wherein said anchor point between the protective tube and enclosure tube is formed to be spaced apart markedly from end faces of the enclosure portion.

10. The tubular conductor assembly according to claim 8, wherein said enclosure portion is formed between end faces of said protective tube and said anchor point between said protective tube and said enclosure tube is disposed approximately centrally between said end faces.

11. The tubular conductor assembly according to claim 8, wherein said enclosure tube is mounted, spaced apart from said anchor point, on at least one loose bearing on said protective tube.

12. The tubular conductor assembly according to claim 8, wherein said phase conductor is supported via a holding insulator fixed relative to said enclosure tube, and said holding insulator is disposed offset to said anchor point with respect to said tube axis.

13. The tubular conductor assembly according to claim 12, which further comprises a holding insulator, movably disposed relative to said enclosure tube and adjacently said fixed holding insulator, on said phase conductor.

14. The tubular conductor assembly according to claim 8, wherein said enclosure tube includes a length compensator.

15. The tubular conductor assembly according to claim 8, wherein said enclosure tube and said protective tube have substantially circular cross sections, and a ratio of a diameter of said protective tube to a diameter of said enclosure tube lies between a square root of 3 (√3) and e.
